(19) United States
(12) Patent Application Publication
(10) Pub. No.: US 2015/0242793 A1
(43) Pub. Date: Aug. 27, 2015

(54) SYSTEMS AND METHODS FOR AUTO-OPTIMIZATION OF GAMIFICATION MECHANICS FOR WORKFORCE MOTIVATION

(71) Applicant: BUNCHBALL, INC., Redwood City, CA (US)

(72) Inventors: Matthew K. Williams, San Francisco, CA (US); Nicholas Mark Goodman, San Mateo, CA (US); Anupam Singhal, Union City, CA (US)

(21) Appl. No.: 14/499,217

(22) Filed: Sep. 28, 2014

Related U.S. Application Data
(60) Provisional application No. 61/943,370, filed on Feb. 22, 2014.
(60) Provisional application No. 61/943,370, filed on Feb. 22, 2014.

(51) Int. Cl. G06Q 10/06

(52) U.S. Cl. CPC G06Q 10/06398

(57) ABSTRACT

Methods and systems are provided for auto-optimization of gamification mechanics. A gamification platform, hosted on any suitable interface, may collect action data from one or more employee. Gamification mechanics are applied to the actions to compute an effectiveness value for each action. An optimization layer of the system may receive performance metrics for the employee from internal systems, or via third party systems. The performance metrics may be employed to update the gamification mechanics by optimizing weights for each action in a fitness function. Effectiveness predictions for future actions are generated using these optimized weights. The updated mechanics and predictions may be provided back to the gamification platform to iteratively repeat the process.

### CROSS REFERENCE TO RELATED APPLICATIONS

This non-provisional application claims the benefit of and is a continuation-in-part of U.S. provisional application Ser. No. 61/943,370, filed on Feb. 22, 2014, entitled “Systems and Methods for Workforce Analytics”, which is incorporated herein in its entirety by this reference.

### BACKGROUND

The present invention relates generally to systems and methods for the automated optimization of gamification mechanics as it applies to workforce motivational tools. The utilization of gamification techniques to help motivate employees is not a new technique. For example, point systems and symbolic rewards are commonly granted for milestones, such as for patents invented, sales numbers increased, etc. However, these gamification techniques are often generically applied and have very simplistic mechanics due to the inherent difficulties associated with tuning the mechanics to each individual. The present disclosure addresses this shortcoming of existing workplace gamification attempts by providing automated optimization of the gamification mechanics.

While gamification techniques in the workplace can be effective in motivating employees, they tend to be extremely basic systems. For example, a plaque or engraved memento if often awarded when an inventor in a company has a patent filed or issued. In some workplaces, it becomes a competition between employees who can accumulate the most mementos. This is an example of the most basic gamification technique: awarding a prize for the completion of a discrete action.

Other examples of existing gamification techniques employed are the awarding of points for completion of internal procedures. For example, in a laboratory setting, completing safety training modules may result in the awarding of “safety points” which may be redeemed later for prizes. By abstracting the activity to points which may be redeemed for any number of prizes, the employees gain the ability to customize their rewards, which often leads to greater employee participation.

Within the sales community, gamification techniques may be readily applied since sales and marketing employees have many discrete and quantifiable actions that they may perform. Obviously, closing a sale, and generating revenue, is paramount to the position, and is often rewarded using a bonus or commission scheme. However, the intermediate steps are not typically addressed, which may result in the employees not optimizing their time or efforts. This is where gamification techniques may be particularly useful as they may assist in optimizing employee performance by directing such intermediate activities. For example, an employee may be very ambitious and concerned with closing deals, however may find that cold calls are tedious, and not recognize their importance in generating more sales opportunities. Gamification may be employed to steer the employees' behaviors in order to optimize their results by identifying where an employee is deficient, and working to improve these weaknesses.

Unfortunately, generating the mechanics for such complicated gamification schemes is non-trivial. Often it requires in depth analysis by a manager, or dedicated team, to identify what game rules should be applied. To do this across an organization with many employees is extremely time consuming, and futile given employee turnover. Thus, rather than generate personalized gamification mechanics for every employee, organizations often must settle for a “one size fits all” approach, where game mechanics for an “average” employee are applied to everyone.

While this solution does provide performance enhancement in the aggregate, it does not take into consideration individual differences, and thereby fails to optimize performance on any granular level. Thus, even though overall performance improves, this improvement is less than it could be.

It is therefore apparent that an urgent need exists for systems and methods that are capable of auto-optimizing gamification mechanics in order to improve employee performance. Such systems and methods would ensure the gamification techniques employed continually refine in order to drive employees to optimal performance. Such systems and methods may likewise be tied to employee performance rating systems for the generation of performance scorecards.

### SUMMARY

To achieve the foregoing and in accordance with the present invention, systems and methods for auto-optimization of gamification mechanics are provided. In particular, systems and methods for auto-optimization of the mechanics may be employed to steer employees toward optimal activities.

In some embodiments, a gamification platform, hosted on any suitable interface, may collect action data from one or more employee. In some cases just the single employee's actions are collected; however, in other embodiments it may be desirable to collect the action data from larger groups of employees. For example, it may be desirable to collect action data from a department of employees, an organization of employees, a division of employees, a reporting structure of employees, and/or a cohort of employees by tenure. Of course other means of dividing up the employees into useful cohorts (such as by geographic location, client services, or product association) is likewise contemplated by embodiments disclosed herein.

After the action data has been collected, the gamification layer may apply gamification mechanics to the actions to compute an effectiveness value for each action. A/B testing, multivariant testing, and evolutionary algorithms all may be employed in order to compute the effectiveness for each action. These effectiveness values may be aggregated for every action the employee undertook to compute a total point value for the employee. The goal of the gamification system is to drive the employees score to an optimal level, which should translate into increased performance by the employee due to the employee engaging in highly effective activities.

An optimization layer of the system may receive performance metrics for the employee from internal systems, or via third party systems. Examples of such third party systems include Customer Relations Management (CRM) systems, and the like. The performance metrics may be employed to update the gamification mechanics. This updating of mechanics is accomplished by optimizing weights for each action in a fitness function. Fitness functions may take the form of ƒ(A)=[w₀, w₁, . . . wₙ]×[a₀, a₁, . . . aₙ], where w is the weight for each given action a. In alternate embodiments, the fitness function may be expanded to include analysis of macro and global levels of an organization. In such embodiments the fitness function may be given as ƒ(A)=ƒ_{micro}(A)+ƒ_{macro}(A)+ƒ_{global}(A), where ƒ_{micro} is a fitness function for the employee, ƒ_{macro} is a fitness function for at least one of the department of employees, the division of employees, the reporting structure of employees, and the cohort of employees by tenure, and ƒ_{global} is a fitness function for the organization of employees.

The optimization layer may also generate effectiveness predictions for future actions using these optimized weights. The updated mechanics and predictions may be provided back to the gamification platform to iteratively repeat the process. By repeating over and over, the game mechanics are continually refined in order to provide more accurate scoring of user actions. In this manner, the game provides effective feedback to the employee for what value each action takes actually provides to the company. By incentivizing high scores in the game, the company may effectively drive employee performance to greater improvement.

The optimization layer may also be configured to capturing metrics to reveal point inflation. In some embodiments, the captured metrics include any of points per action versus number of actions, points per challenge versus number of actions, and points per level versus level versus number of actions.

Lastly, an administrative control panel may be provided in some embodiments. The administrative control panel enables an administrator to input business goals, game configurations and receive feedback regarding how well the system is working.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 shows an example logical block diagram for an auto-optimization of gamification mechanics system, in accordance with some embodiments;

FIG. 2 shows an example logical block diagram for an application in the gamification layer of the auto-optimization system, in accordance with some embodiments;

FIG. 3 shows an example logical block diagram for the optimization layer of the auto-optimization system, in accordance with some embodiments;

FIG. 4 shows an example graph for the scoring of employee actions within the auto-optimization system, in accordance with some embodiments;

FIG. 5 shows an example flow chart for the process of auto-optimizing game mechanics, in accordance with some embodiments;

FIG. 6 shows an example logical block diagram for a workforce analytics system, in accordance with some embodiments;

FIG. 7 shows further details of the performance assessor, in accordance with some embodiments;

FIG. 8 shows further details of the data collection module, in accordance with some embodiments;

FIGS. 9-18 show a series of flow charts for the process of workforce analysis, in accordance with some embodiments;

FIG. 19 shows an example illustrations of the conversion of relational data into graphical data, in accordance with some embodiments;

FIG. 20 shows an example illustrations of a scorecard for employee performance assessment, in accordance with some embodiments; and

FIGS. 21A and 21B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

As previously noted, there is a large number of employee management and assessment software packages currently available to Human Resource (HR) divisions for the tracking and assistance of employee performance. Some of these systems include gamification techniques that may be employed within the workforce to increase employee motivation and productivity. However, these existing systems are typically a “one size fits all” approach, or otherwise require significant investment from managers to customize the game mechanics to meet the needs of each employee.

The presently disclosed systems and methods provide novel means for tailoring and updating the game mechanics used for employee motivation using an automated optimization feedback loop. These systems and methods allow for more effective and less time consuming gamification techniques to be applied to an employee cohort. Such systems and methods are valuable as a standalone product, or may further be incorporated into a wider employee assessment system.

### I. Gamification Mechanics Auto-Optimization

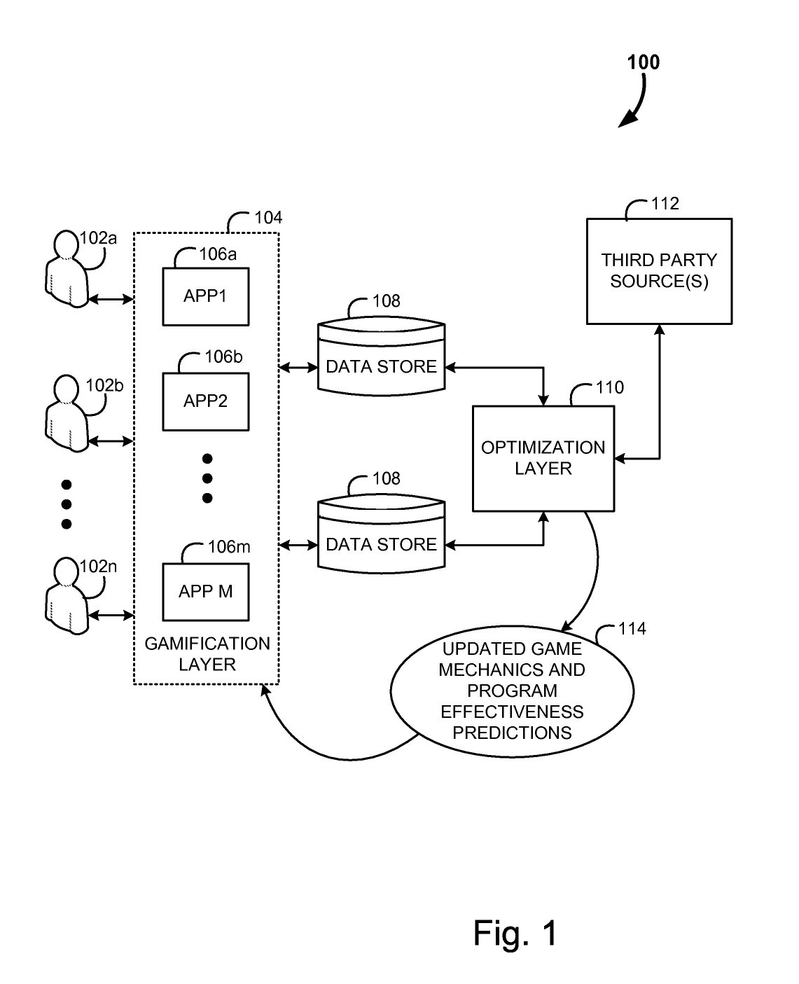

Referring now to FIG. 1, a gamification system is provided, shown generally at 100, which is enabled to perform automated updating of game mechanics in order to motivate employees. In this example diagram, a plurality of users 102a-102n interact with a gamification layer 104. The users 102a-102n may be employees, contractors, or agents, in some embodiments. This interaction may be via multiple applications 106a-106m.

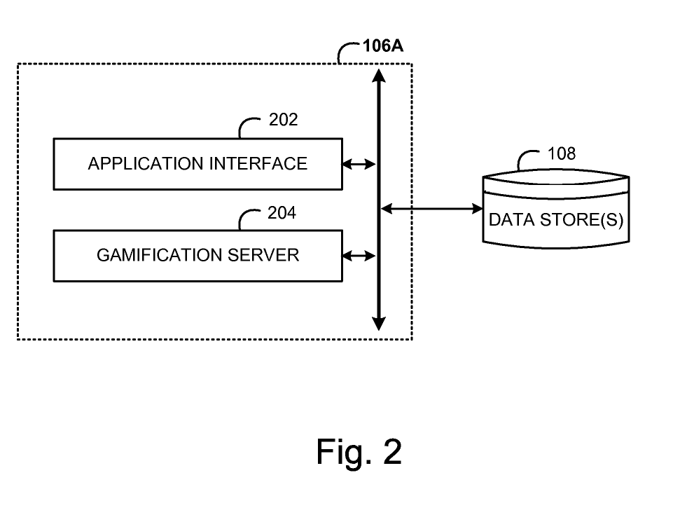

Moving to FIG. 2, the applications 106a may include backend servers 204 that generate the game that is then presented to the users via interfaces 202. The game presented to the user 102a via the interface 202 typically includes a graphical user interface where the user 102a can input actions that have been recently taken. The server 204 receives the actions and quantifies their “value” according to set game mechanics. This value may then be converted into a prize or score that is presented to the user 102a. The server 204 may also provide the user 102a with recommended actions in order to assist in the generation of even higher scores. In some embodiments, the gamification layer 104 is configured to be accessible by a myriad of devices such as smartphones, laptops, tablets, etc.

As gamification techniques are known, details of the exact user interface and means of presenting suggestions to the user 102a will not be discussed in considerable detail. Rather attention will be directed toward the novel means for the auto-optimization of the game mechanics, and the means of integrating such systems into an employee performance system. As such, it should be understood that any suitable game interface could be utilized in conjunction with the presently disclosed gamification layer 104.

Returning to FIG. 1, as noted, the gamification layer 104 provides motivational gamification techniques to elicit positive behaviors from the respective user 102a. For example, points or awards may be provided a user 102a when a particular activity is accomplished. If the user 102a is part of a sales team, these activities may be actions such as calling potential customers, closing a deal, attending a networking event, etc. The actions taken by the user are scored by the gamification layer 104, and stored within one or more data stores 108.

The data stores 108 maintain persistent data about the user's 102a game-playing activities, as well as work performance data that has been compiled from external systems. Moreover the data stores 108 may associate any given user 102a to a division, department and organization. In some embodiments, it may be helpful to compile results from all employees within a division of a company. For example, all sales staff within the company may have their data aggregated for optimizing game mechanics for that group. Alternatively, even less granular aggregations may be beneficial, such as all employees in North America, or even all employees in the company as a whole. Indeed, even many organizations, or subcomponents of an organization, may be aggregated as is desired. For example, it may be helpful to aggregate game payer data from all sales associates from across many different companies to generate a “global sales” data set. While company organizational structure and geography are common means of aggregating employee game playing data, alternative means may be employed, such as aggregation by tenure within the organization, employee's age, employee grade, job title, etc.

The data held within the data store 108 is then provided to an optimization layer 110 for the generation of updated game mechanics, as well as program effectiveness predictions 114. In the generation of these updated mechanics and predictions 114 the optimization layer 110 may also utilize third party data sources 112. Such third party data may include employee performance data from HR feeds, external CRM data, and the like. This data may be supplied to the optimization layer 110 via FTP, APIs, or other server-to-server means of data communication.

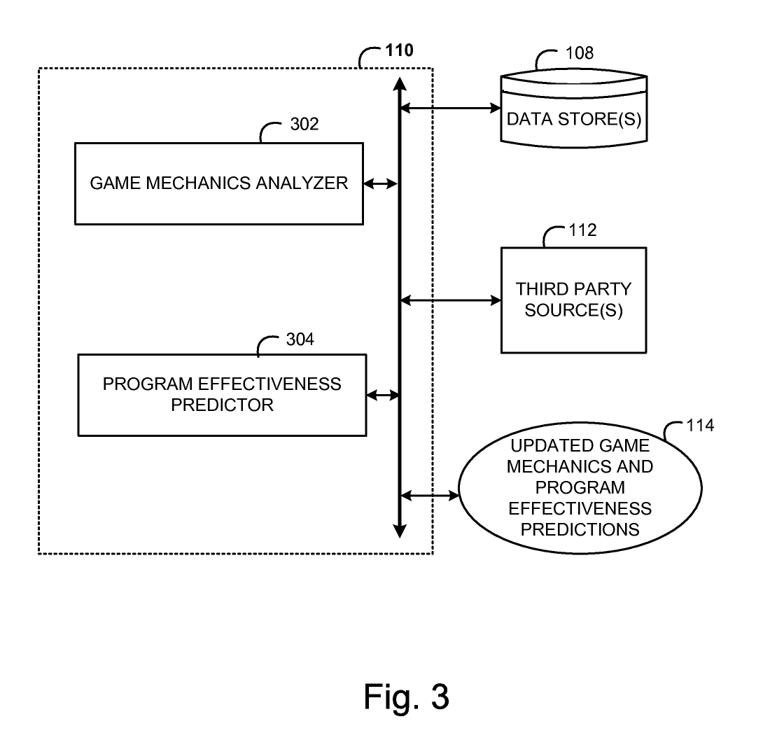

Moving to FIG. 3 a more detailed view of the optimization layer 110 is provided. The optimization layer includes a game mechanics analyzer 302 and a program effectiveness predictor 304. The Game mechanics analyzer compares the activities taken by the user 102a and compares them against collected performance data obtained from the third party data sources 112. For example, returning to the example of a sales associate, assume the associate engages in a number of networking events. A third party system is typically utilized to track sales associate progress. For example a Customer Relationship Management (CRM) system such as salesforce.com can track and record sales performance of the sales person. These sales results may be compared against the activities undertaken by the sales person in order to determine the effectiveness of any one action, or actions taken in conjunction with one another. This allows the system to generate weights for an action, or series of actions, that impact the point value assigned to it. These weights are integrated into the game mechanics to ensure continual improvement of the gamification techniques. The new game mechanics are provided to the gamification layer 104 for updating of the application screens accordingly.

In addition to informing future quantification of activities, these weights may be employed by the system to make predictions of how certain activities will result in increased sales performance. These predictions are generated by the program effectiveness predictor 304 and are used to gauge how accurate the optimized game mechanics are once updated sales performance data is received.

The period between collection of game data and the updating of game mechanics may be a set period of time, or may be delayed to ensure enough data is collected. Additionally, the system may also delay game mechanics updating in order to account for activities to mature. For example, attending a networking event may be very important to the generating of new business, but may take a while before it results in actual sales. A system that updates game mechanics too regularly may determine that networking events are valueless since the resulting sales have not yet occurred. Just as damaging, when the sales from said networking do materialize, they may be mistakenly attributed to another activity that may have nothing to do with the closure of the sales. Thus to ensure proper causality attribution, a sufficiently long period of time may be allowed to elapse between game mechanics optimizations.

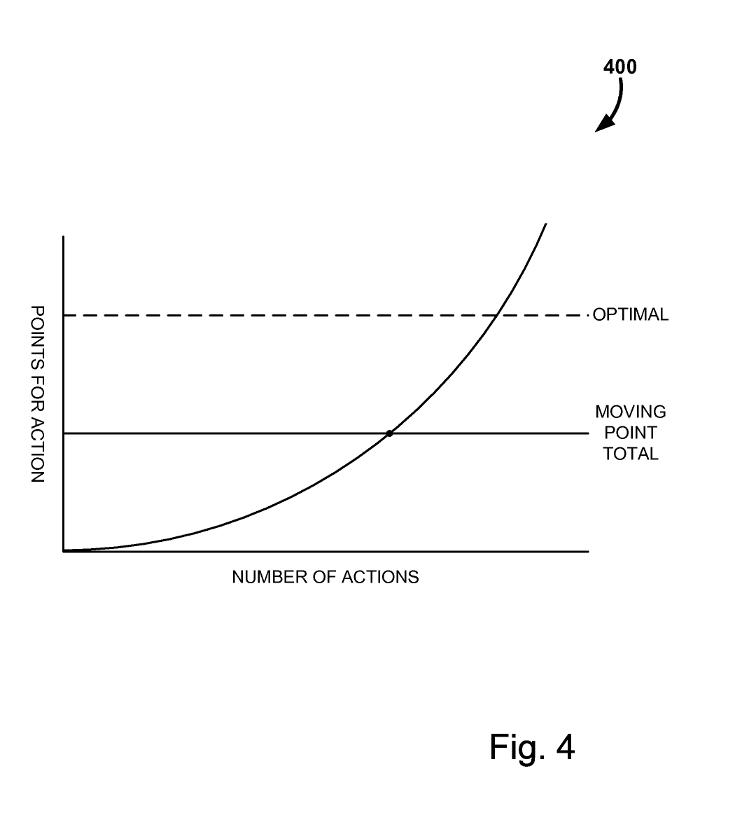

FIG. 4 provides an example graph for the scoring of employee actions within the auto-optimization system, shown generally at 400. In this example graph, the “actions” taken by the user 102a are presented along the x-axis of the graph. These actions could include any relevant work activity, such as “call prospective client”, “read an article”, “enter contest”, “attend a networking event”, “reach out to contact”, etc.

The system scores the actions, or series of actions, based upon the game mechanics. This results in points granted for the actions, which is displayed along the y-axis of the example graph. The objective of one embodiment of the gamification system is to advance the moving score along the pathway toward the optimal score.

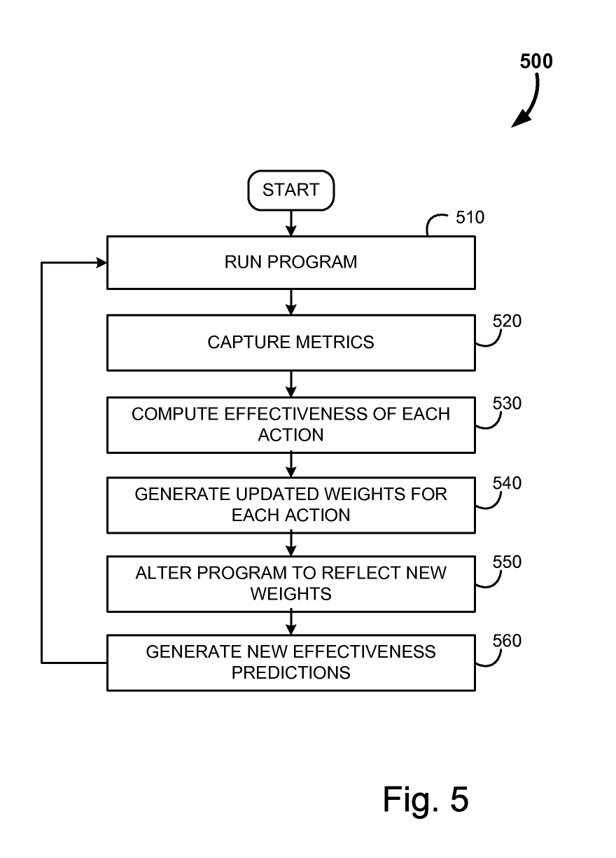

FIG. 5 shows an example flow chart 500 for the process of advancing the score toward an optimal score, as described above. In this process, the gamification applications are initially run (at 510) by the employee. The employee can access the gamification layer via any appropriate screen, including smartphones, laptop or desktop computers, dummy terminals, and the like. Gamification servers, which may be remotely located, generate the applications for display to the users. In some embodiments the gamification server may be accessed via a web page. All games are centered on activities that promote the business goal of the organization. The user/employee inputs actions that have been taken via the game interface.

The gamification layer captures these actions associated with a given user, and stores them in data stores. By applying the game mechanics to the raw action data metrics for the employee may be captured (at 520). Examples of game mechanics include, for example, points, actions, badges, challenges and rewards earned for completion of tasks. The purpose of having the user perform the gamified actions is to optimize the user's job performance. Thus, for the example of the sales associate, actions previously discussed related to completing sales (networking, cold calling potential customers, etc.) are run through the game mechanics to generate the appropriate points/badges/rewards.

Often the metrics generated are points per action versus the number of actions, points per challenge versus the number of actions, points per level versus level versus number of actions, for example. Of course any kind of computer metrics may be employed by some embodiments of the gamification system.

One benefit of the computation of these metrics is the determination if point inflation is present. Point inflation occurs when additional actions by the user produce fewer points, and this may be remedied via increasing point grants, or diversifying user activities. On the flip side the opposite may occur where the users may aim to “rig” the game by exploiting loopholes in the game mechanics to ensure elevated point values without actually increasing job performance. By identifying these sources of mechanics vulnerability, the mechanics may be altered to ensure that additional actions have reduced returns.

After the metrics have been computed for the current set of actions, performance metrics may be collected and stored for the employee. These performance metrics may be collected from third party systems, such as a CRM system, or via local systems, such as an HR performance system. For a user, the optimization layer can compare the action data, and subsequently computed metrics, with the performance metrics to compute the effectiveness of each action (at 530).

The determination of effectiveness may be generated actively, or through historical analysis, in some embodiments. When actively determining action effectiveness, known techniques like A/B testing, or multivariant testing, may be employed.

When employing a historical analysis to determine action effectiveness, the currently collected performance metrics for the user are compared against previous predictions of the performance metrics. These predictions are generated each time the optimization layer updates the game mechanics in order to assist with a historical analysis of action effectiveness. Evolutionary algorithms, or other known techniques, may be employed to determine action effectiveness when comparing the current metrics to metric predictions.

Once action effectiveness has been calculated (regardless of the method used), new weights can be computed for each action (at 540). The actions and the weights are combined to compute a fitness function, as presented below:

ƒ=Σ(weights×actions)

For example, for a sales associate (A), each sales action (networking event, entering contest, calling prospective customers, etc.) is assigned a weight, resulting in a fitness function ƒ(A), shown below:

ƒ(A)=[w₀,w₁, . . . wₙ]×[a₀,a₁, . . . aₙ]

Where w is the weight; and

a is each action taken by the associate.

The optimization layer aims to optimize the values for each weight “[w₀, w₁, . . . wₙ]”. In computing an update for these weights for a given user, the system is enabled to expand the scope of its analysis beyond the individual. In particular, the fitness function may be examined upon any number of levels, including the individual, a departmental aggregate, organizational level, global level, etc. Above is disclosed the many ways in which the data may be aggregated, including geographic delineations, organizational delineations, tenure, etc. For example, for the sales associate A, the function ƒ for computing the update may be in the following form:

ƒ(A)=ƒ_{micro}(A)+ƒ_{macro}(A)+ƒ_{global}(A)

Where ƒ_{micro} is a fitness function for the individual employee;

ƒ_{macro} is a fitness function for an intermediate group that the employee belongs to, such as a department in an organization; and

ƒ_{global} is a fitness function for a global group which the employee belongs, such as for the organization as a whole.

Of course, each employee may have a different fitness function ƒ dependent upon his or her role in an organization, and based upon how the analysis is desired to be performed. For example, an employee with a very specialized customer niche may not benefit from inclusion of a fitness function for all sales people in the organization, as this won't be representative of the employee. However, similar sales groups, associated with similar niche customers, but located in different organizations may be highly relevant.

Once the new weights have been determined through the optimization discussed above, the new weights may be incorporated into the gamification layer's applications (at 550) as updated game mechanics. New effectiveness predictions are then generated using the updated game mechanics (at 560). These effectiveness predictions are utilized, as previously mentioned, when performing a historical analysis of action effectiveness, as described above.

Once the new game mechanics are implemented and the effectiveness predictions made, the process starts over again by repeating the running of the gamification layer applications (at 510), now with the updated weights. The whole process continues in an iterative fashion in order to continually refine the game weights, and thereby continually push the employee to activities which optimize the employee's performance.

In addition to the interfaces provided to the users to access the gamification layer, some embodiments of the auto-optimization gamification system allow for administrator control. A control panel may be made accessible by administrative workers, or any other manager or power user with the appropriate permissions. The purpose of this control access stems from the fact that the administrator is aware of the business goals for the organization, and may manually wish to make these goals central to the systems optimization.

In most businesses, profitability is the most desired goal, and the system, by default, may optimize employee actions to achieve this goal. However, under some circumstances, the organization goal may not be primarily profit driven. For example, a new product line may wish to sacrifice profitability in exchange for sales volume/market share growth. In such a case, a floor profit/loss may be set, and the goal of maximizing sales volumes is inputted by the administrator. In contrast, in other cases, the organization may have a limited supply chain capability, and thus the goal of sales being below a threshold may be paramount, and under such constraints the profits are optimized to be maximized.

In some embodiments, the business goals may be inputted as a natural language statement, for example “increase sales revenue to $15 million.” In such embodiments, the system may employ a parser and syntax engine to generate machine readable rules. Details of this process are omitted as such techniques of natural language interpretation are known in the art. In alternate embodiments, a set of configurable, but common, business goals may be presented to the administrator, and may be configured by administrator selection of the appropriate format and filling in of the relevant fields. Additionally, known web techniques, such as drag and drop menus, knobs, and numerical fields may all be employed to provide a means for inputting these goals/business priorities in a user-friendly manner.

The administrator control panel may be a web based application that ties directly into the optimization layer, or may be an external system accessible by the administrator. When the goal setting system is external to the optimization layer, abstracted rules may be provided from the goal setting system to the optimization layer.

The inclusion of an administrator control panel allows broad business goals to be considered as part of the automated optimization process, thereby sparing the administrator from needing to change the game mechanics manually and individually.

In addition to being able to set business goals and priorities, the administrator control panel may also access the gamification layer's configurable settings that allow the administrator to set items such as the rate points are rewarded, award types, badges, game types used, etc. For example, if the employees are able to redeem points for tangible goods (such as a cash payout, gift card, or prize), the administrator may wish to configure the rate of points being awarded to match the rewards to ensure that the reward remains obtainable, yet rare enough to still be an effective motivator. Likewise, if employees can get points that can be redeemed for tangible goods, things like badge awards may not be desired because they may be deemed “inferior” by employees as compared to redeemable points. The control panel allows the administrator to configure these gamification settings to ensure that employees are motivated properly.

Lastly, the administrator control panel provides feedback indicating how well the gamification system is working. This feedback may include statistics on how effective an employee, or subset of employees, are performing, changes in employee performance, employee point accumulation and trends, etc. The feedback may be useful to identify problem employees, or problems in the gamification system, which may be addressed. For example, feedback may indicate that in aggregate, the sales associates have increased performance by 10% over the previous quarter; however, one associate has decreased performance by 20%. Such an incongruity would help an administrator or manager to investigate why the particular employee's performance is inconsistent with the trends of the department.

### II. Performance Assessment

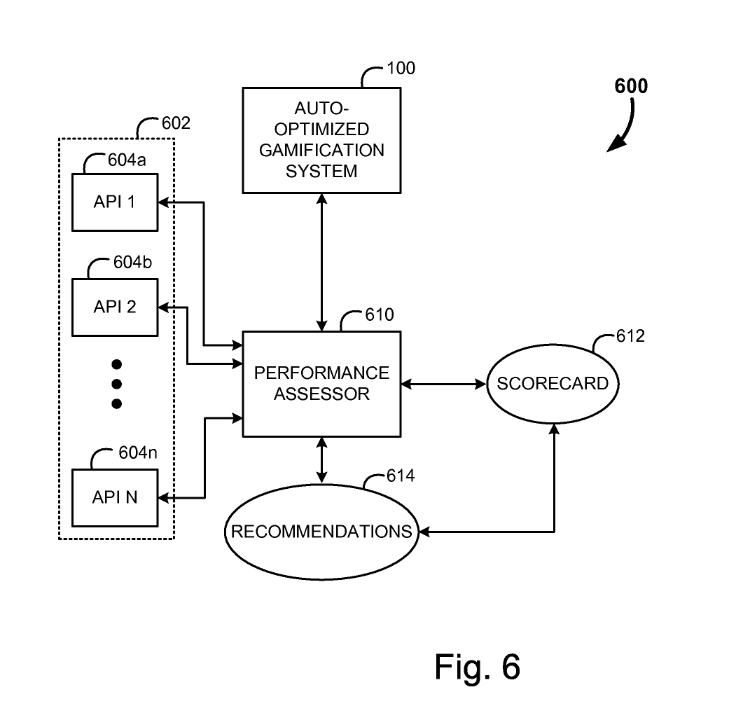

FIG. 6, an example logical block diagram for a workforce analytics system 600 is provided, in accordance with some embodiments. The workforce analytics system 600 includes a collection of data sources 602 which may comprise many application interfaces (APIs) 604a-604n. Each API 604a-604n may couple to some enterprise system or database which includes data relevant to the employee's performance. These data sources include internal and external enterprise software systems utilized by the company, or made available to the company.

For example, sales tracking software may have an API for which sales data generated by the employee may be accessed. A timecard software system may be accessed for employee attendance and truancy information. Other example systems that may be drawn upon for data pertinent to the employee includes, but is not limited to, social collaboration tools, customer relationship management (CRM) software, learning management systems (LMS), human resources databases, and others. In addition to industry and company standard performance metrics, general and specialized performance indices (e.g., Deal Closer Index for a salesperson) may be calculated from the aforementioned datasets, when applicable. Illustrated as a separate system (although logically it could be considered one of the data sources 602) is the auto-optimized gamification system 100.

The gamification data, performance suggestions, and employee performance analytics calculated and collected by the auto-optimized gamification system 100 may all be provided to the performance assessor 610, along with data from the other data sources 602, for the purpose of generating analytics for the employee. These analytics, which will be disclosed in considerable detail below, includes the generation of a single index value which indicates how well the employee is performing. This index is incorporated into a scorecard 612 along with additional auto-populated data. A set of recommendations 614 optimized to improve the employee's performance is also generated. These recommendations 614 make likewise be incorporated into the scorecard 612 for extra guidance.

The employee performance index which is generated for the scorecard 612 is a normalized computer modeled score that assesses the employee's overall performance in his or her given role. Separately, trending of the employee performance index is possible in order to contextualize performance of the employee over various temporal scenarios.

The employee performance index may also be generated for a segment of a company rather than for an individual employee. In this manner, a team, or even a division, within the company may be ranked for their relative performance. Again, the index is normalized for job function. The index is a quantified sum of all relevant behaviors within enterprise software applications. This index is analogous to a consumer's FICO score, where an individual has a computed score that measures success (i.e., credit worthiness in this analogy).

Inputs for the scorecard vary to reflect pertinent attributes of the job function. These inputs reflect both company-wide and personalized metrics. The following are examples of standard inputs (including, but not limited to function, or metric) shown in relation to tables 1 and 2:

TABLE 1
Example Personal Employee Metrics

| Section | Metric(s) |
|---|---|
| Topline | Employee Name, Photo, Division, |
| | Team, Position |
| Attributes | Length of service, Experience Level, |
| | Education, Core Skills |
| Performance Metrics | Stable: (detailed later) |
| | Job Specific: (detailed later) |
| Accreditations | Company awards, promotions, |
| | certifications, completed training |

TABLE 2
Example Employee Performance Metrics

| Function (Job Specific) | Metric(s) |
|---|---|
| Any (Stable) | Attendance, Years in service, Compliance, |
| | Adoption, Utilization, Promotions, Social |
| | Activity (UGC) |
| Sales | Revenue, Forecast Accuracy, Closing Rate, |
| | Calls made, lead time contact rate, Pipeline |
| Service | First call resolution (FCR), Customer |
| | satisfaction (CSAT), Average handle time |
| | (AHT), Calls received, Cases closed |
| Finance | Percentage internal audit completion, |
| | Percentage Collections, Collections |
| | Amount, Percentage of Past Due vendor |
| | claims, certifications, external audit |
| | completion, days to close fiscal quarter, |
| | days to close fiscal year, payments made |
| | within SLA (employee expenses) |
| HR | Performance reviews completed, Team |
| | development, Culture rating, Company |
| | Turnover, Percentage Training compliance |

In some embodiments, the employee performance index can be compared (due to normalization) and aggregated. This enables comparing the performance of two or more employees, even across different departments within one company, and even across different companies.

Aggregation allows computing an index for an entire department, company, or industry sector. This is achieved by computing mean, median, mode, weighted average, or other averaging function on the collection of EP Index scores for all of the employees in the specified group.

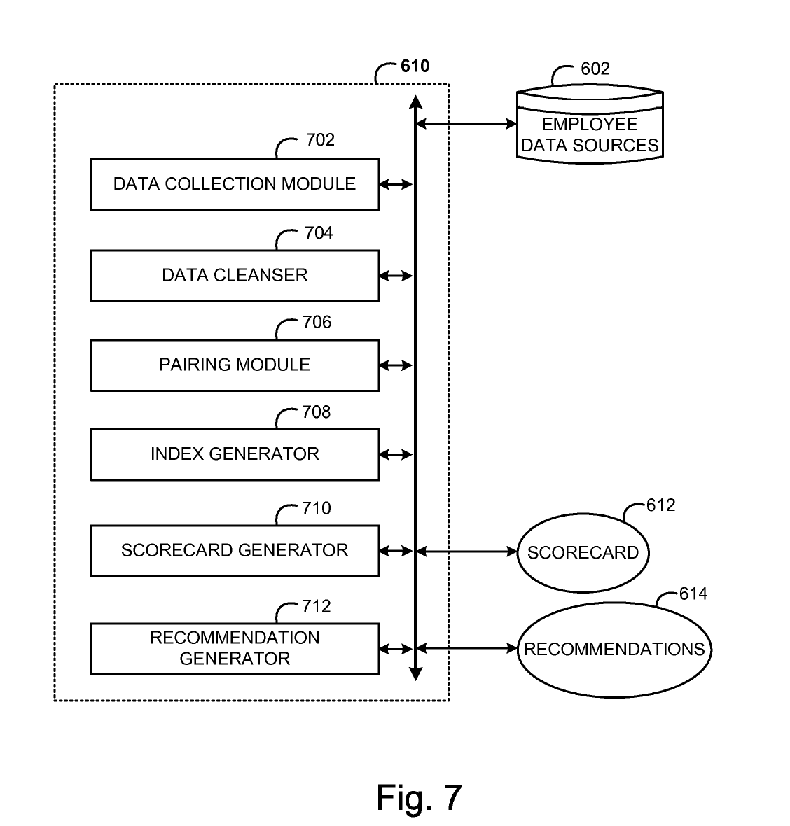

FIG. 7 shows further details of the performance assessor 610, in accordance with an embodiment. As can be seen, the performance assessor 610 includes a series of subcomponents coupled to one another in a manner that enables communication between the separate sub-components. This connection may be merely logical in practice, or may consist of a physical coupling, such as a bus structure. In yet alternate embodiments, each sub-component of the performance assessor 610 may actually be embodied within a single processing and memory device, and the distinctions between these components made in relation to FIG. 7 are merely for the sake of clarity.

The performance assessor 610 includes a data collection module 702 which is configured to extract the data from the various data sources 602 for subsequent cleansing in the data cleanser 704. Action and outcome data are paired by a pairing module 706.

Next, the paired data is supplied to the index generator 708, where the employee performance index is generated. More detail is provided below in relation to the means of generating the index. This index, along with other employee information may be populated into a scorecard template by the scorecard generator 710. A recommendation generator 712 may optimize for actions the employee may take to maximally increase their performance. These recommendations 614 may be provided separately and/or be incorporated into the scorecard 612.

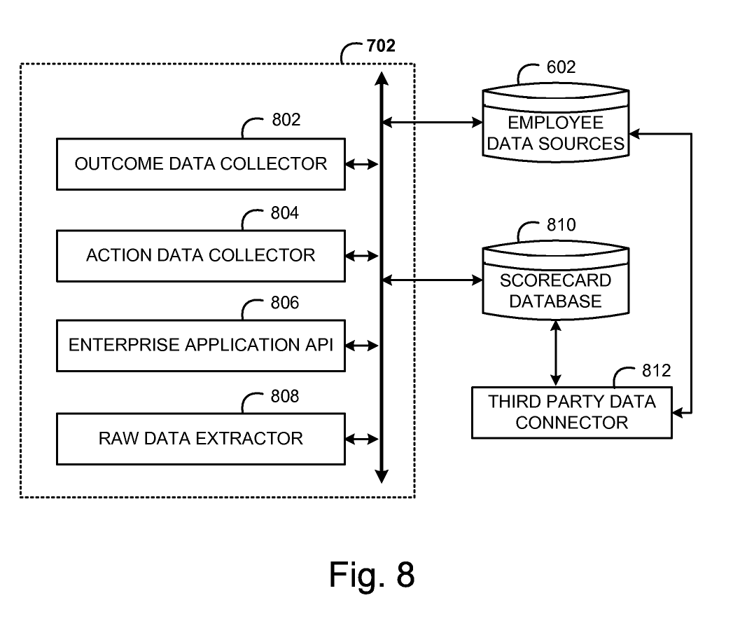

FIG. 8 shows further details of the data collection module 702, in accordance with an embodiment. As previously noted, the present systems and methods benefit greatly from their ability to access significantly more employee data that any current performance rating system. This wealth of data enables the generation of meaningful indices of performance, and accurate recommendations for increasing performance. However, accessing such large amounts of data comes with a few drawbacks: the vast amount of data collected means that there is extraneous data that necessarily needs to be filtered from the final comparative data. This process of cleaning the data will be provided below.

Returning to the data collection module 702, as with other logical block diagrams presented herein, the subcomponents illustrated are in logical or physical communication with one another. The data collection module 702 includes an outcome data collector 802, which pulls outcome data from various data sources 602. For example, sales volumes for an employee may correspond to an outcome which is relevant to the employee's performance. Likewise, an action data collector 804 collects action data for the user. For example, the number of sales calls the employee made may be considered an action the employee undertook.

Although not necessarily separate, an enterprise application API 806 may glean data from internal enterprise application software systems, and likewise the raw data extractor 808 may pull raw data from systems that normally are not configured for reporting out to a HR performance assessment system. For example, a price optimization system may be employed for sales associates when generated sales quotes. Such a system may track win rations, pocket margin, and other relevant data which the raw data extractor 808 may glean directly for the purposes of employee performance analysis.

All collected data may be organized within a scorecard database 810 for ready retrieval and analysis. In addition, third party data connectors 812 may provide information to the database 810 in order to assist in analysis. For example, general industry trends may be helpful in the normalization of the employee's performance, and external information may be leveraged in order to generate these distinctions.

For example, if a sales employee increases sales by 10% over the quarter, and yet the industry, on average, saw a 40% increase in sales, the system may leverage this external data to more accurately gauge the employee's performance.

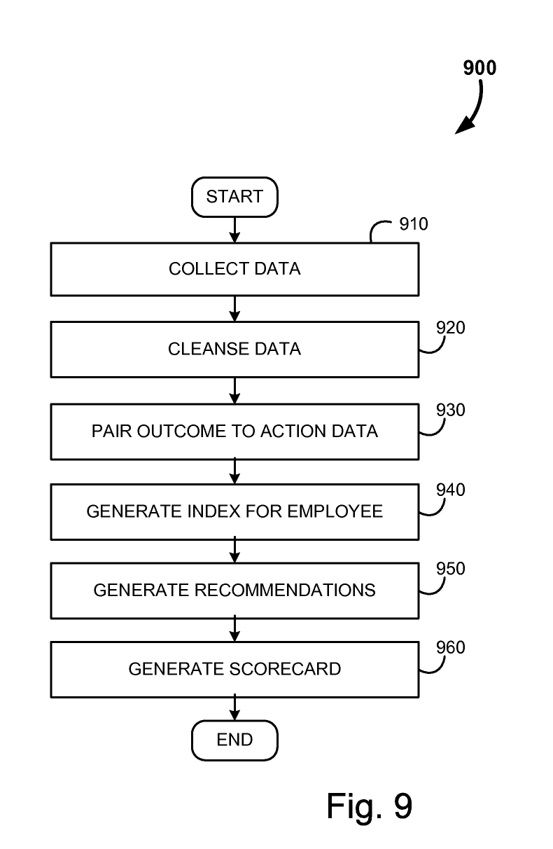

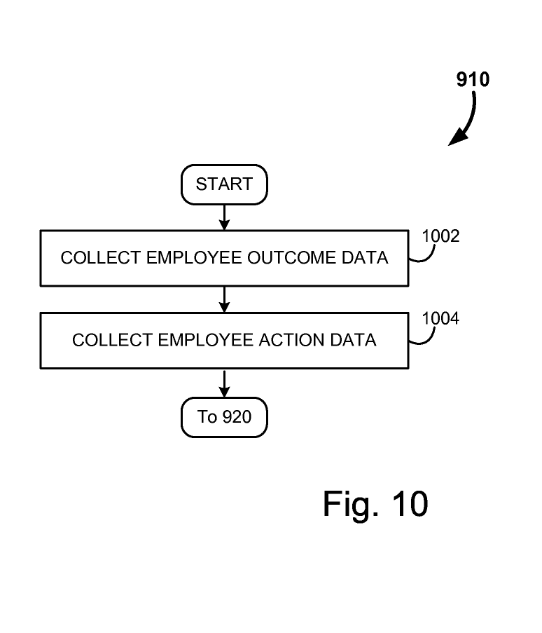

Now that the basic system architecture for the performance evaluator has been described in considerable detail, attention will now be directed to a series of flowcharts detailing the process for scorecard generation and performance analysis. Directing attention to FIG. 9, a top level process flow diagram 900 is provided. In this example process, initially data is collected (at 910). FIG. 10 provides a more detailed flow chart for this data collection process, whereby the system collects employee outcome data (at 1002) and employer action data (at 1004). As previously noted, action data is actions or decisions made by the employee that have an impact upon performance. Outcome data is the resulting outcomes that are influenced by the employee actions (as well as external factors).

Returning to FIG. 9, after data collection, the data is cleansed (at 920) in order to filter out extraneous or erroneous data. As previously noted, the present system draws upon a large volume of internal and external enterprise systems, therefore a very large amount of data is available to the system in order to gauge the employees performance. However, in many instances, not all the data available is required to sufficiently assess the employee. For example, for a salesperson, sales data generated by a CRM system may be highly pertinent. However, for a research associate, such CRM data may have little or no bearing upon the employee's performance.

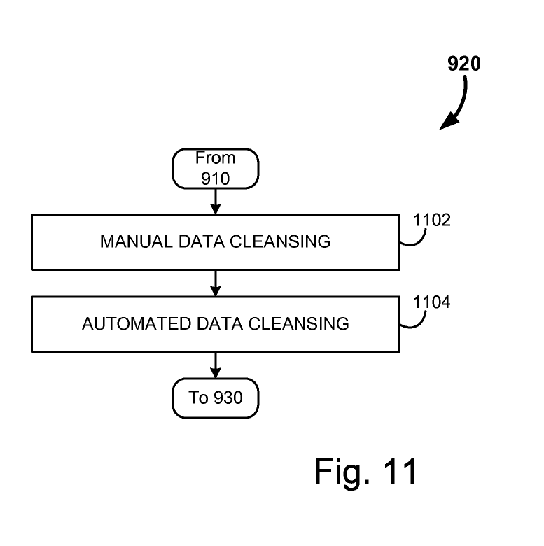

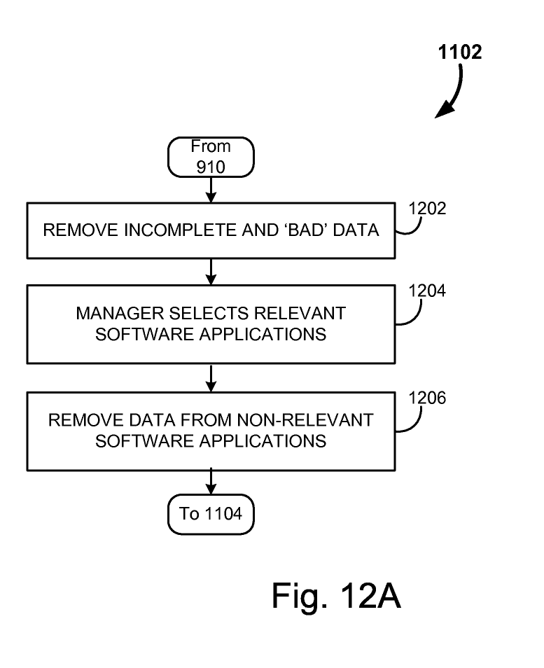

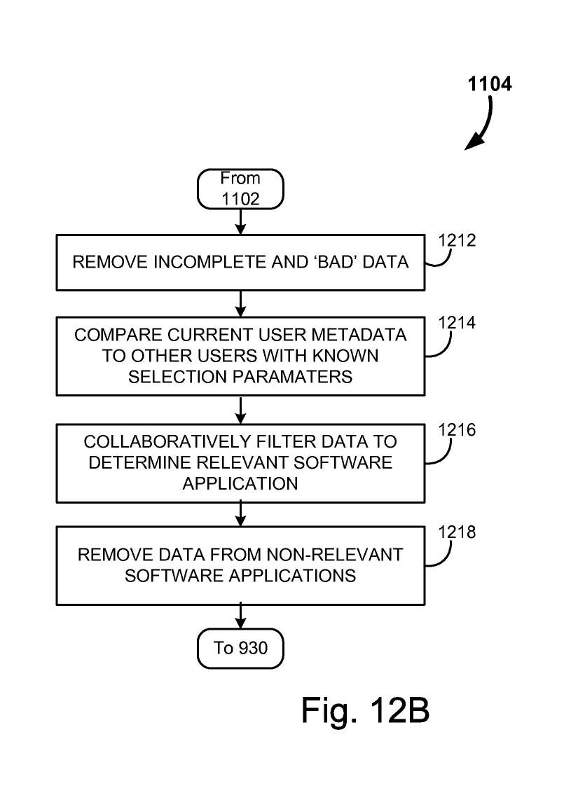

FIG. 11 provides a high level process diagram for the data cleansing sub-process. This data cleansing process is broken down into a manual data cleansing step (at 1102), and an automated data cleansing step (at 1104). FIGS. 12A and 12B provide greater detail into these two steps, respectively.

In the manual data cleansing step of FIG. 12A, a user (typically a manager of HR representative) will remove incomplete and “bad” data (at 1202). Typically this data is corrupted, nonsensical, or poorly documented. For example, if an employee completed a series of sales negotiations without utilizing a price negotiation system, the data from the system may be deemed incomplete. The manager may then have the option of correcting the erroneous records, or excluding them from the analysis as ‘bad data’.

Next, the manager (or HR representative) may select which applications are relevant to the employee (at 1204). As noted above, a sales associate and a researcher may rely upon very different systems in order to properly gauge their performance. A manager, or other individual familiar with the employee's role, is able to readily select which data sources are relevant to the employee's performance. The system is next able to filter out non-relevant software applications (at 1206) based upon whether they were or were not selected as being relevant.

The automated process for data cleansing, as seen in FIG. 7B, operates in a very similar manner. Initially, incomplete or “bad” data is removed (at 1212), typically by comparing the data to rules designed to weed out erroneous data. The employees metadata is then compared to other employees for a best match (1214) where the other employees selection patterns are known. For example, in a sales force, a new OEM sales associate may be compared to the other employees, including consumer sales associates and other enterprise sales associates. The metadata for the user, including job descriptors, responsibilities, grade level, pay scale, and the like, may determine which employee type the employee belongs to. Known clustering analysis may be employed to make this determination, in some embodiments.

The purpose of matching the employee to other known employees is that the selection criteria may be mapped from one employee to another. Thus, the data available for the employee may be filtered according to the similarities between employees in order to identify relevant data sources (at 1216). For example, a research associate may have his performance criteria adopted from other similar research associates as opposed to say, a sales director, for example. Lastly, as with the manual data cleansing, the data sources used to assess the employee may be filtered in order to exclude non-relevant software applications (at 1218).

Note that, in some embodiments, manual data cleansing may be performed in conjunction with automated data cleansing. In these cases, the resulting data sets may be compared against one another. Discrepancies in the data sets may be resolved via combination of relevant data or via an override by either the manual system or the automated cleansing system. In alternate embodiments, the manual data cleansing or the automated data cleansing may be performed independent from one another. In some cases, where there are no similar employees, a manual data cleansing may be preferable. In alternate situations, where there are a number of other employees with similar job functions, it may be more consistent and efficient to rely upon automated data cleansing. Often, based upon company size and organization, the cleansing steps may be configured to best meet the needs of the company.

Returning to FIG. 9, after data has been cleaned, the system pairs the outcome data to the action data (at 930). This pairing determines causality between outcomes and action data utilizing statistical analysis of large datasets for many employees. These causality models may be applied to the user's action to generate predictive pairings.

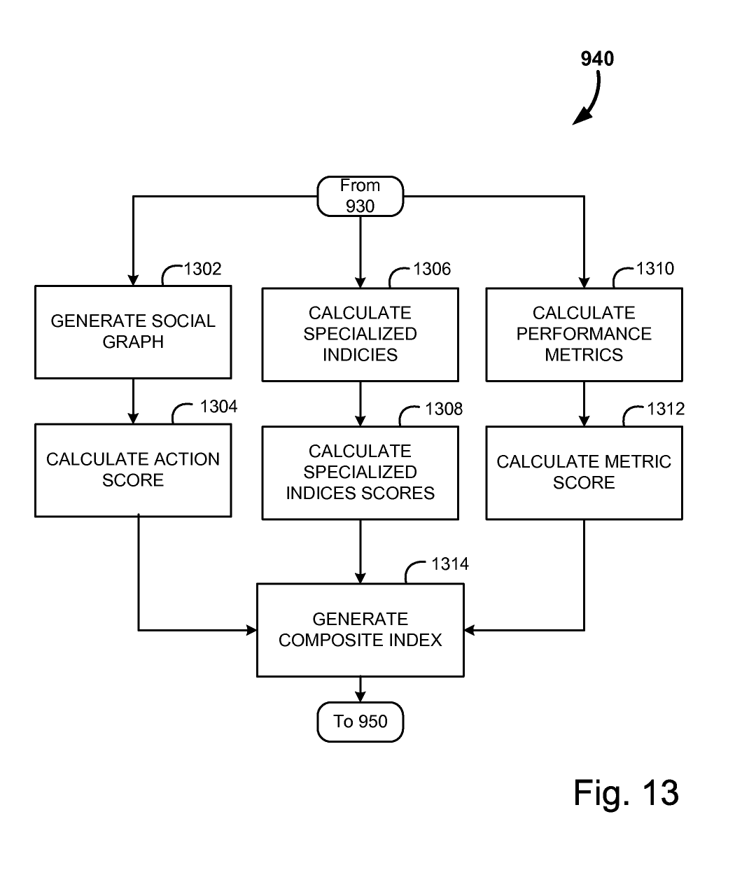

Subsequently, an employee performance index is generated (at 940). FIG. 13 provides a more detailed illustration of the process of generating the employee performance index. This process includes three sub-processes that may be performed in parallel or in series.

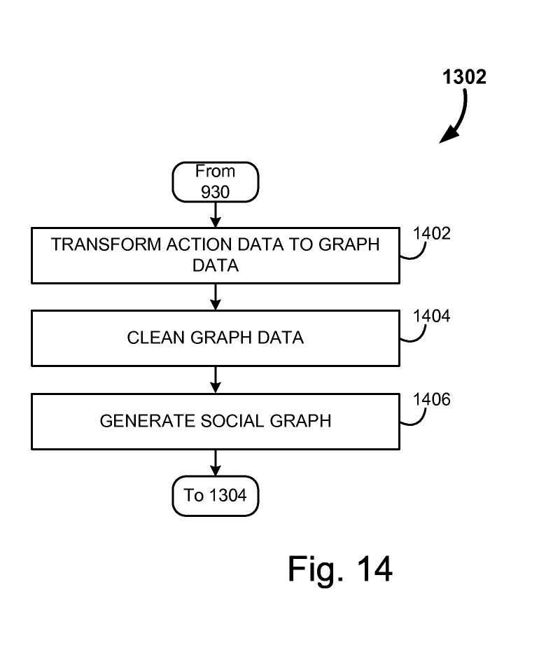

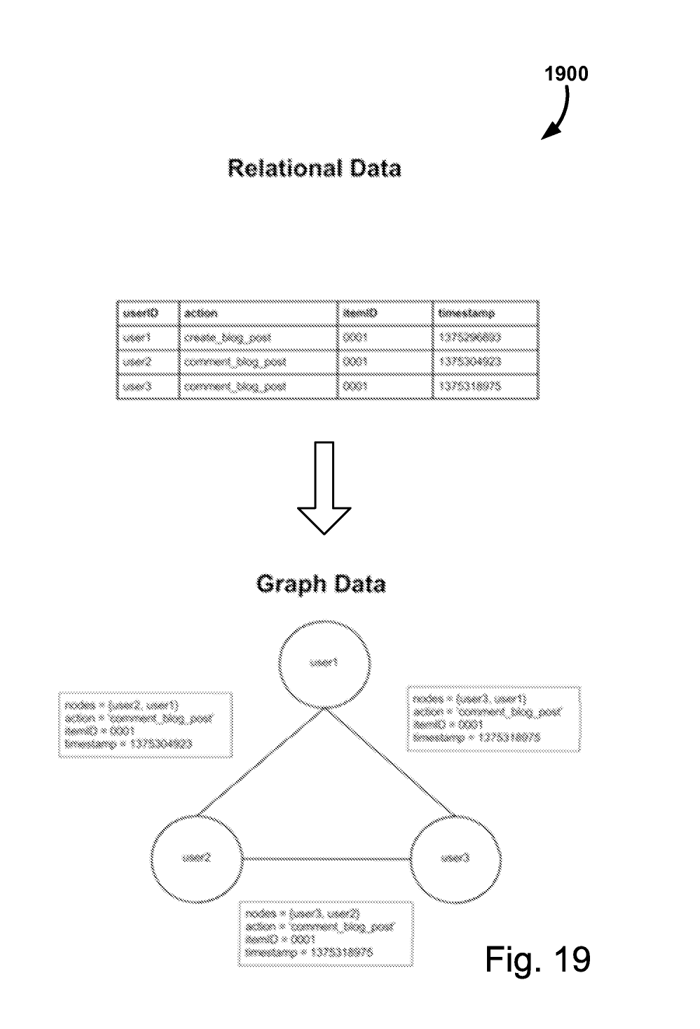

The first includes the generation of a social graph (at 1302) based upon relational data in the filtered data set. This is the algorithm used to compute an enterprise social graph from data collected in enterprise software applications. An enterprise social graph provides a map of “human resources” and enables the quantification of influence within a network. This algorithm transforms the action data collected into graph data, which permits the creation of an enterprise social graph. FIG. 14 discloses the mechanism of generating a social graph. The action data identified as relevant to the employee is transformed into graphical data (at 1402). This graphical data is cleaned (at 1404) and used to construct the social graph (at 1406). FIG. 19 illustrates, by way of example, how relational data may be transformed into graphical structures. The relational data shown here is generated by arranging an action (here blog post creation or commenting) and providing user identification and other pertinent information. The relational data is then transformed into a graph where each employee is a node, and the actions between the employees/users are used to connect the nodes. In this example, the commenting actions by user 2 and user 3 generates connections between them and the originator of the blog, user 1.

Returning to FIG. 13, after the social graph is generated, it can be used to calculate an action score (at 1304). The action score may be defined by the following equation:

$$action {score}_{a} = \frac{\begin{matrix}{\sum }_{b = 1}^{n} bussiness {value}_{{action}_{b}} * \\ time {differential}_{{action}_{b}} * {software}_{{action}_{b}} * {influence}_{{action}_{b}}\end{matrix}}{normalization {factor}_{a}}$$

Where:

action scoreₐ=the aggregated and normalized score for actions completed by user a;

actionₐ=the a^{th} action;

business valueₐ=the numeric weight associated with the business value or outcome of action a;

softwareₐ=the numeric weight associated with the piece of software in which action a was performed;

influenceₐ=the numeric value of the network influence of action a; and

normalization factorₐ=the numeric value by which the sum of all weighted actions are normalized by for individual a.

In a parallel process, specialized indices are calculated for the employee (at 1306). Specialized indices are indices which have specialized meaning for a particular employee role (e.g., a deal closer index for a sales person). These indices, once defined, may be readily calculated from the relevant data sets. Next, a specialized indices score is calculated (at 1308) based upon the indices. The specialized indices score may be defined by the following equation:

$$indices {score}_{a} = \frac{{\sum }_{b = 1}^{n} {score}_{b} * bussiness {value}_{{index}_{{score}_{b}}}}{normalization {factor}_{a}}$$

Where:

indices scoreₐ=the aggregated and normalized score for indices of user a;

scoreₐ=the a^{th} index score;

business valueₐ=the numeric weight associated with the business value or outcome of index score a; and

normalization factorₐ=the numeric value by which the sum of all weighted index scores are normalized by for individual a.

In the final sub process, the performance metrics for the employee are calculated (at 1310). Performance metrics are industry and company standard performance metrics. Next, a metric score is calculated (at 1312) for the performance metrics. The metric score may be defined by the following equation:

$$metric {score}_{a} = \frac{\begin{matrix}{\sum }_{b = 1}^{n} {score}_{b} * metric normalization \\ {factor}_{{score}_{b}} bussiness {value}_{{metric}_{{score}_{b}}}\end{matrix}}{normalization {factor}_{a}}$$

Where:

metric scoreₐ=the aggregated and normalized score for performance metrics of user a;

scoreₐ=the a^{th} metric score;

metric normalization factorₐ=the numeric value by which metric score a is normalized by;

business valueₐ=the numeric weight associated with the business value or outcome of metric score a; and

normalization factorₐ=the numeric value by which the sum of all weighted index scores are normalized by for individual a.

After the action score, specialized incises score, and metric score have been calculated, they may be combined into a composite index (at 1314) which is the employee performance index. The employee performance index is calculated by the following equation:

$$EP {Index}_{a} = \frac{\begin{matrix}\begin{matrix}action {score}_{a} * {importance}_{action {score}_{a}} + \\ indices {score}_{a} * {importance}_{indices {score}_{a}} +\end{matrix} \\ metric {score}_{a} * {importance}_{metric {score}_{a}}\end{matrix}}{normalization {factor}_{a}} ;$$

Where:

EP Indexₐ=the employee performance index for the a^{th} user;

action scoreₐ=the aggregated and normalized score for actions completed by user a;

indices scoreₐ=the aggregated and normalized score for indices of user a;

metric scoreₐ=the aggregated and normalized score for performance metrics of user a;

importanceₐ=the numeric weight associated with the importance of score a; and

normalization factorₐ=the numeric value by which the sum of all weighted scores are normalized by for individual a.

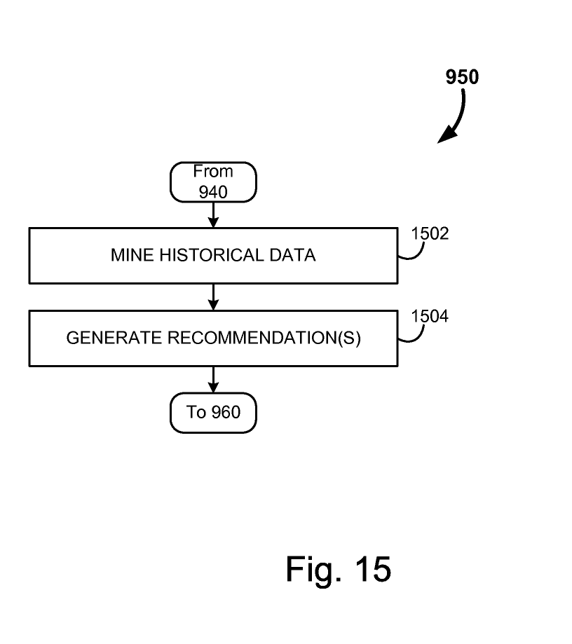

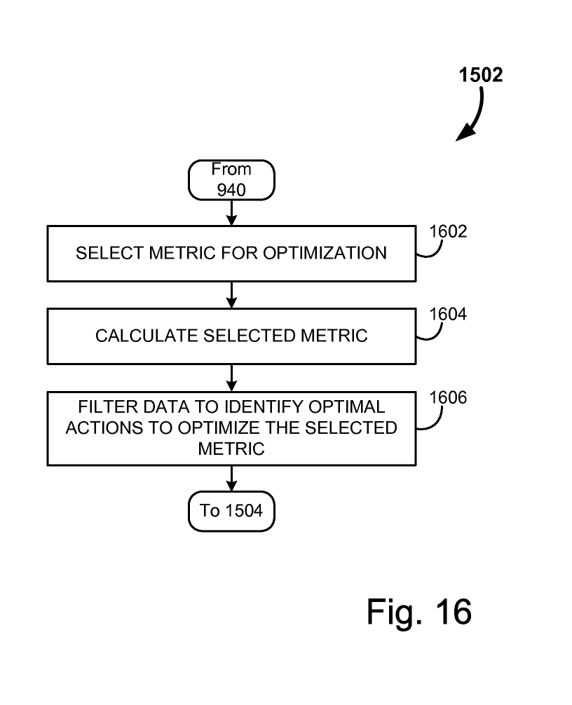

Returning to FIG. 9, once the employee performance index is generated, over time, a historical record of this score becomes available. Some embodiments use this historical data to recommend actions for the employee to take in order to improve his or her score (at 950). FIG. 15 provides a more detailed illustration of this recommendation process. Initially, the historical data is mined (at 1502), as shown in greater detail in FIG. 16. Data mining includes selecting a metric for optimization (at 1602), calculating the selected metric (at 1604), and filtering data to identify optimal actions that may be done by the employee to optimize the selected metric (at 1606). The historical mining enables the identification of employee “best practices” for achieving the best outcomes. These best practices may be compared to the employee actions to generate the recommendations (at 1504).

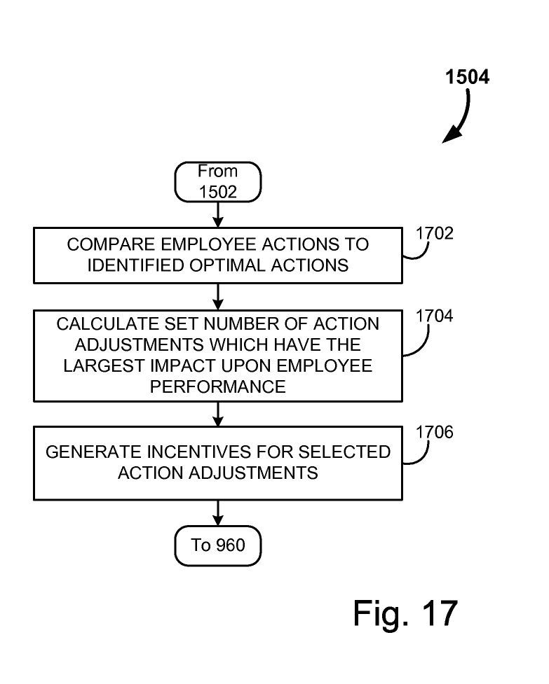

FIG. 17 illustrates this recommendation process. Once identified, these optimal actions can be used to further optimize the gamification implementation (i.e., macro optimization) described previously, or they can be fed into an automated behavioral recommendation engine (i.e., micro optimization). The employee actions are compared against the optimal “best practices” (at 1702) to determine which actions if adjusted would yield the largest impact upon the employee's performance index (at 1704). The system may then generate cost effective incentives for the user to adopt these actions (at 1706). The behaviors recommended are incentivized using gamification mechanics including, but not limited to, notifications, challenges, and point rewards, as previously discussed. For example, if the system identifies that employees who attend three training workshops per year have a 7% efficiency gain, thereby increasing company profits by $15,000 per year, the system may recommend a $500 bonus per training workshop, up to three workshops. Such incentives enable the employee to have a tangible reward (or penalty) for meeting recommendation goals, while still ensuring that the company interests are being maximized. Incentive values may be based upon historical compliance measures. For example, in the past it may have been determined that a $300 bonus achieved only a 30% compliance, yet at $500 achieves a 90% compliance, thereby making this incentive measure the most optimal for the company.

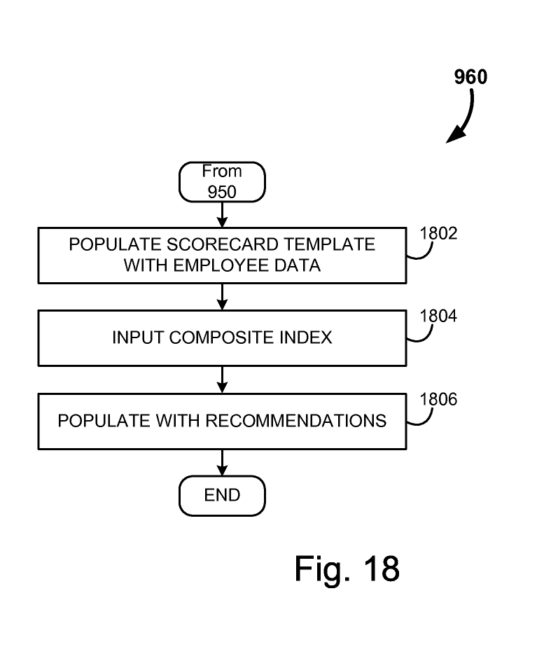

Returning to FIG. 9, after the recommendations have been generated, a final scorecard for the employee may be generated (at 950). FIG. 18 provides a more detailed example of this sub-process, whereby a scorecard template is populated with employee data (at 1802), the performance index (at 1804) and with the recommendations (at 1806).

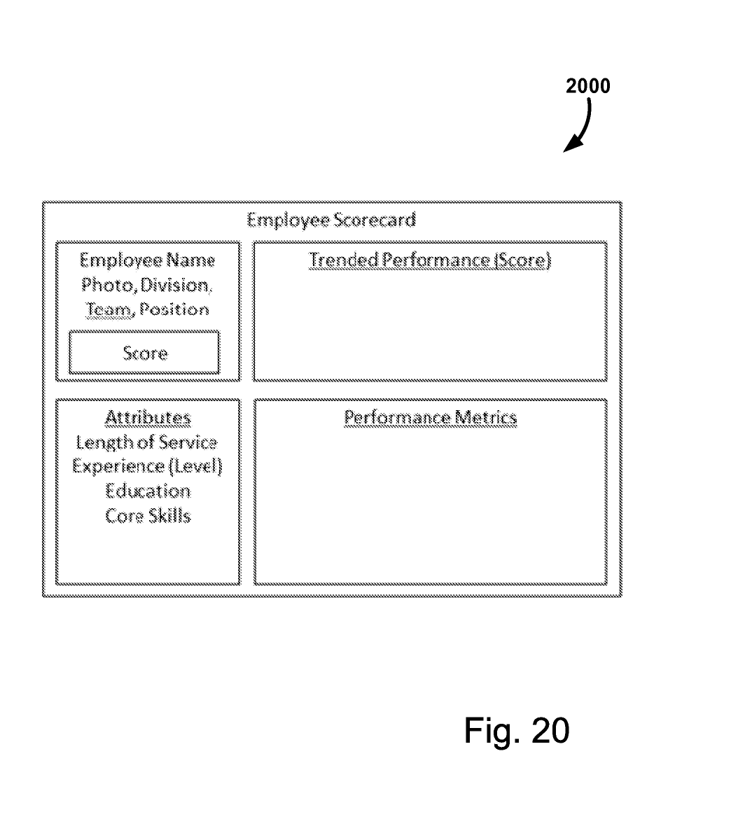

FIG. 20 shows an example illustrations of such a scorecard 2000. Again, it can be seen that the scorecard includes employee information (name, title, division, etc.) along with the composite performance index score. Trends in performance are also provided, along with performance metrics and attributes of the employee. These scorecard templates may be customized to meet the needs of each company.

### III. System Embodiments

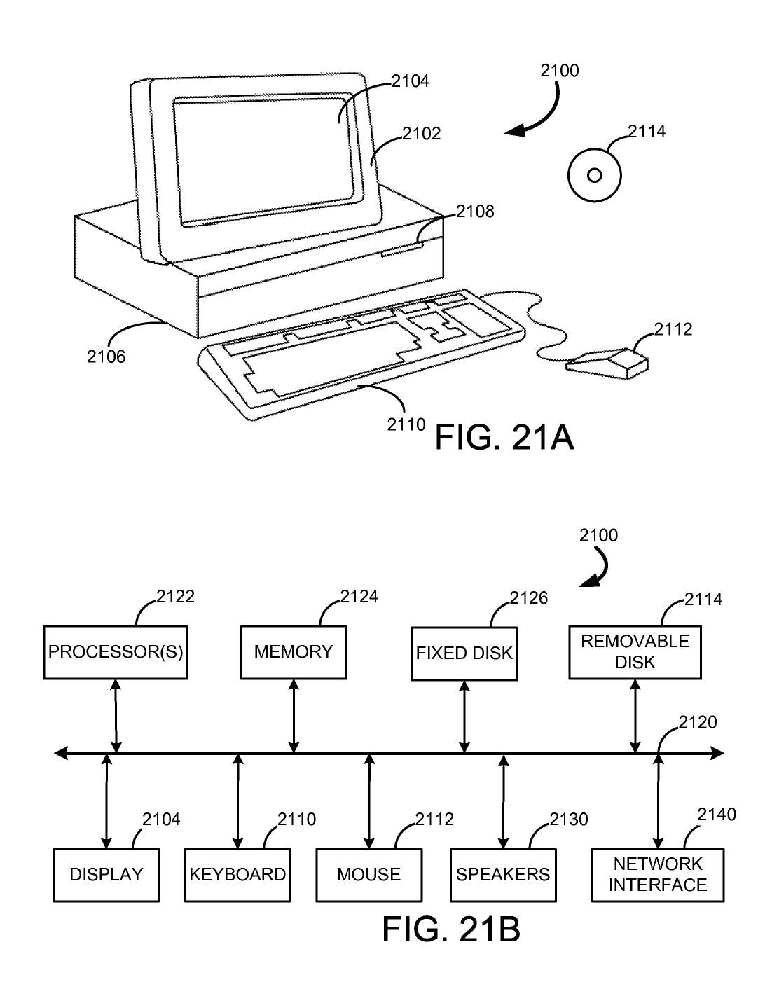

FIGS. 21A and 21B illustrate a Computer System 2100, which is suitable for implementing embodiments of the present invention. FIG. 21A shows one possible physical form of the Computer System 2100. Of course, the Computer System 2100 may have many physical forms ranging from a printed circuit board, an integrated circuit, and a small handheld device up to a huge super computer. Computer system 2100 may include a Monitor 2102, a Display 2104, a Housing 2106, a Disk Drive 2108, a Keyboard 2110, and a Mouse 2112. Disk 2114 is a computer-readable medium used to transfer data to and from Computer System 2100.

FIG. 21B is an example of a block diagram for Computer System 2100. Attached to System Bus 2120 are a wide variety of subsystems. Processor(s) 2122 (also referred to as central processing units, or CPUs) are coupled to storage devices, including Memory 2124. Memory 2124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2126 may also be coupled bi-directionally to the Processor 2122; it provides additional data storage capacity and may also include any of the computer-readable media described below. Fixed Disk 2126 may be used to store programs, data, and the like and is typically a secondary storage medium (such as a hard disk) that is slower than primary storage. It will be appreciated that the information retained within Fixed Disk 2126 may, in appropriate cases, be incorporated in standard fashion as virtual memory in Memory 2124. Removable Disk 2114 may take the form of any of the computer-readable media described below.

Processor 2122 is also coupled to a variety of input/output devices, such as Display 2104, Keyboard 2110, Mouse 2112 and Speakers 2130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2122 optionally may be coupled to another computer or telecommunications network using Network Interface 2140. With such a Network Interface 2140, it is contemplated that the Processor 2122 might receive information from the network, or might output information to the network in the course of performing the above-described auto-optimization of workforce gamification. Furthermore, method embodiments of the present invention may execute solely upon Processor 2122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; solid state memory; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Note that, the term “employee” and “user” are often employed interchangeably within this disclosure. These terms may refer to not only as individuals for which auto-optimization of gamification techniques is desired, but also divisions, teams, whole companies and even industries for which such gamification is desired.

While this invention has been described in terms of several embodiments, there are alterations, modifications, permutations, and substitute equivalents, which fall within the scope of this invention. Hence, it should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for auto-optimization of gamification mechanics for increasing workforce performance comprising:
collecting action data for at least one employee via a gamification platform;
applying gamification mechanics to the action data to compute effectiveness of each action;
receiving performance metrics for the at least one employee;
updating the gamification mechanics by optimizing weights for each action; and
providing the updated gamification mechanics to the gamification platform.

2. The method of claim 1 further comprising generating effectiveness predictions for future actions based on the optimized weights, and providing the predictions to the gamification platform.

3. The method of claim 2 wherein new action data is collected for the at least one employee and the updated gamification mechanics are applied to compute effectiveness for each action.

4. The method of claim 3 wherein the processes of updating gamification mechanics, generating effectiveness predictions, and returning them to the gamification platform is repeated as an iterative process.

5. The method of claim 1 wherein the at least one employee includes at least one of a department of employees, an organization of employees, a division of employees, a reporting structure of employees, and a cohort of employees by tenure.

6. The method of claim 5 wherein the optimized weights are generated by optimizing a fitness function for each employee.

7. The method of claim 6 wherein the fitness function for the employee is given as: ƒ(A)=[w₀, w₁, . . . wₙ]×[a₀, a₁, . . . aₙ], where w is the weight for each given action a.

8. The method of claim 6 wherein the fitness function for the employee is given as: ƒ(A)=ƒ_{micro}(A)+ƒ_{macro}(A)+ƒ_{global}(A), where ƒ_{micro} is a fitness function for the employee, ƒ_{macro} is a fitness function for at least one of the department of employees, the division of employees, the reporting structure of employees, and the cohort of employees by tenure, and ƒ_{global} is a fitness function for the organization of employees.

9. The method of claim 1 wherein the computing effectiveness of each action is performed using at least one of A/B testing, multivariant testing, and evolutionary algorithms.

10. The method of claim 1 further comprising capturing metrics to reveal point inflation, wherein the captured metrics include at least one of points per action versus number of actions, points per challenge versus number of actions, and points per level versus level versus number of actions.

11. The method of claim 1 further comprising providing an administrative control panel for enabling an administrator to input business goals, game configurations and receive feedback.

12. A system for auto-optimization of gamification mechanics for increasing workforce performance comprising:
a gamification platform configured to collect action data for at least one employee, and apply gamification mechanics to the action data to compute effectiveness of each action; and
on optimization layer configured to receive performance metrics for the at least one employee, update the gamification mechanics by optimizing weights for each action, and provide the updated gamification mechanics to the gamification platform.

13. The system of claim 12 wherein the optimization layer is further configured to generate effectiveness predictions for future actions based on the optimized weights, and provide the predictions to the gamification platform

14. The system of claim 13 wherein the gamification platform is configured to collect new action data for the at least one employee and apply the updated gamification mechanics to compute effectiveness for each action.

15. The system of claim 14 wherein the optimization layer iteratively repeats the processes of updating gamification mechanics, generating effectiveness predictions, and returning them to the gamification platform.

16. The system of claim 12 wherein the at least one employee includes at least one of a department of employees, an organization of employees, a division of employees, a reporting structure of employees, and a cohort of employees by tenure.

17. The system of claim 16 wherein the optimization layer is configured to generate the optimized weights by optimizing a fitness function for each employee.

18. The system of claim 17 wherein the fitness function for the employee is given as: ƒ(A)=[w₀, w₁, . . . wₙ]×[a₀, a₁, . . . aₙ], where w is the weight for each given action a.

19. The system of claim 17 wherein the fitness function for the employee is given as: ƒ(A)=ƒ_{micro}(A)+ƒ_{macro}(A)+ƒ_{global}(A), where ƒ_{micro} is a fitness function for the employee, ƒ_{macro} is a fitness function for at least one of the department of employees, the division of employees, the reporting structure of employees, and the cohort of employees by tenure, and ƒ_{global} is a fitness function for the organization of employees.

20. The system of claim 12 wherein the gamification platform computes effectiveness of each action by using at least one of A/B testing, multivariant testing, and evolutionary algorithms.

21. The system of claim 12 wherein the optimization layer is further configured to capture metrics to reveal point inflation, wherein the captured metrics include at least one of points per action versus number of actions, points per challenge versus number of actions, and points per level versus level versus number of actions.

22. The system of claim 12 further comprising an administrative control panel configured to enable an administrator to input business goals, game configurations, and receive feedback.
